(19) United States
(12) Patent Application Publication
(10) Pub. No.: US 2019/0145160 A1
(43) Pub. Date: May 16, 2019

(54) Wooden Veneer-faced Window Shutter

(71) Applicant: Guangxue Jiang, Dalian (CN)

(72) Inventor: Guangxue Jiang, Dalian (CN)

(21) Appl. No.: 15/834,084

(22) Filed: Dec. 7, 2017

(30) Foreign Application Priority Data
Nov. 16, 2017 (CN) 201711133666.4

(51) Int. Cl. E06B 9/02; E06B 9/386; E06B 9/38

(52) U.S. Cl. CPC E06B 9/02; E06B 9/38; E06B 9/386

(57) ABSTRACT

A wooden veneer-faced window shutter, comprising a variety of shutter components, wherein the components comprise a blade, a stile, a rail and a frame, wherein the blade, the stile, the rail and the frame comprise a poplar (or other inexpensive soft wood species) FJL/LVL base and a layer of wood veneer face. The said base and veneer face are with E0 glue. This invention is simple in structure. By combing the cheap FJL/LVL base with the relatively expensive veneer face, this invention has the following advantages: first, it reduces the cost of making wood shutters; secondly, it meets the customer's need for window shutters made of expensive wood species; thirdly, it helps solve the shortage of some rare wood species.

### BACKGROUND OF THE INVENTION

### 1. Field of the Invention

This invention relates to a window shutter. More particularly, this invention relates to a wooden veneer-faced window shutter.

### 2. Description of the Related Art

Window shutters are in great demand both at home and abroad. At present, window shutters and shutter components are mostly made of wood or aluminum alloy. Basswood has always been the first choice in making wooden window shutter. However, recent years have witnessed a remarkable increase in the basswood price due to the scarcity of this wood species. As a consequence, the costs of making basswood shutters and components have risen sharply and are expected to rise further in the future. Besides, American customers are fond of furniture made of expensive wood species, such as red oak, white oak, white ash, black walnut, beech and maple. However, due to the heavy weight of these wood species, it is almost impossible to make shutters with them. Facing all these problems, we decide to make some innovation on the current shutter products.

### SUMMARY OF THE INVENTION

In order to solve the above mentioned problems we invented a kind of wooden veneer-faced window shutter. It is simple in structure. By combing the cheap FJL/LVL base with the relatively expensive veneer face, this invention has the following advantages: first, it reduces the cost of making wood shutters; secondly, it meets the customer's need for window shutters made of expensive wood species; thirdly, it helps solve the shortage of some rare wood species.

The following technical solutions are adopted in this invention. A wooden veneer-faced window shutter, comprising a variety of shutter components, wherein the components comprise a blade, a stile, a rail and a frame, wherein the blade, the stile, the rail and the frame comprise a poplar (or other inexpensive soft wood species) FJL/LVL base and a layer of wood veneer face. The said base and veneer face are glued together with E0 glue.

Furthermore, wherein the wood veneer include red oak, white oak, white ash, black walnut, beech, maple and basswood.

Furthermore, the wood veneer shall be heated and pressed on the base at the temperature of 50° C. −55° C. with E0 glue. The said heating and pressing could be done either with machines or manually.

Furthermore, the wood veneer is rotary cut veneer of 0.1-1.0 mm in thickness. Furthermore, the shape of the inner base is in conformity with the shape of the blade, the stile, the rail and the frame.

By combing the cheap FJL/LVL base with the relatively expensive veneer face, this invention has the following advantages: first, it reduces the cost of making wood shutters; secondly, it meets the customer's need for window shutters made of expensive wood species; thirdly, it helps solve the shortage of some rare wood species.

### BRIEF DESCRIPTION OF THE DRAWINGS

FIG. 1 is a schematic cross-sectional structure of a blade.

FIG. 2 is a schematic cross-sectional structure of a stile.

FIG. 3 is another schematic cross-sectional structure of a stile.

FIG. 4 is a schematic cross-sectional structure of a rail.

FIG. 5 is a schematic cross-sectional structure of a frame.

FIG. 6 is another schematic cross-sectional structure of a frame.

### DETAILED DESCRIPTION OF THE PREFERRED EMBODIMENTS

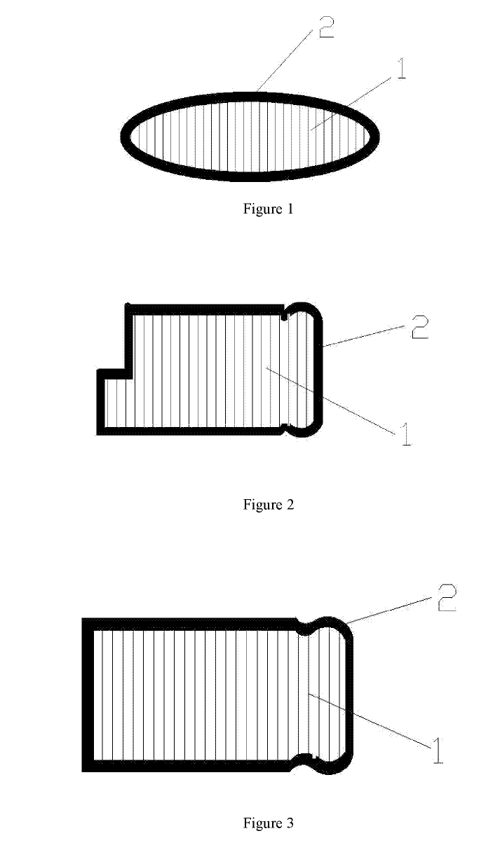

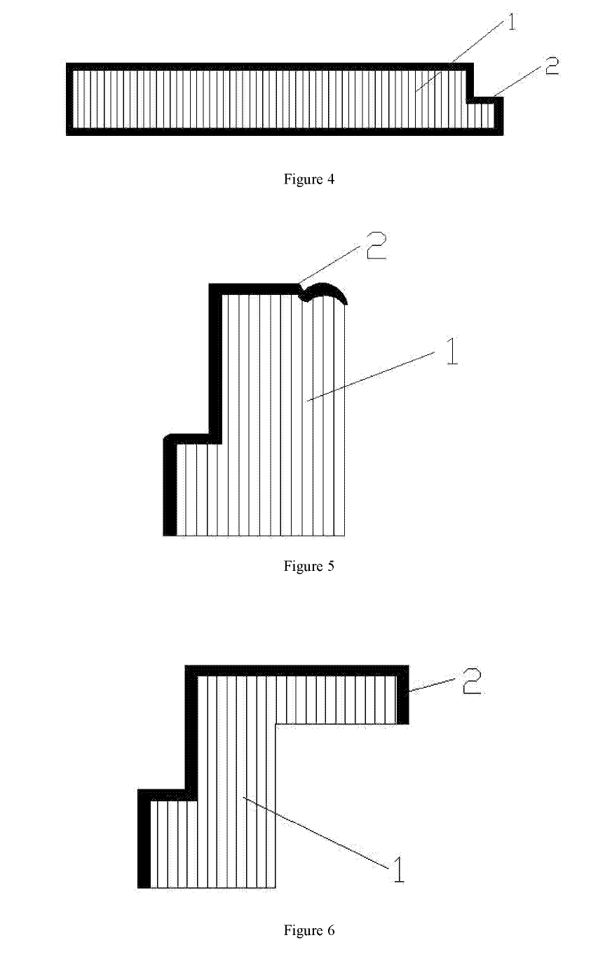

The invention is further described as follows with reference to the drawings. As shown in FIG. 1-6, a wooden veneer-faced window shutter, comprising a variety of shutter components, wherein the components comprise a blade, a stile, a rail and a frame, wherein the blade, the stile, the rail and the frame comprise a poplar (or other inexpensive soft wood species) FJL/LVL base and a layer of wood veneer face. The said base and veneer face are glued together with E0 glue. The wood veneer include red oak, white oak, white ash, black walnut, beech, maple and basswood. The wood veneer shall be heated and pressed on the base at the temperature of 50° C. −55° C. with E0 glue. The said heating and pressing could be done either with machines or manually. The wood veneer is rotary cut veneer of 0.1-1.0 mm in thickness. The shape of the inner base is in conformity with the shape of the blade, the stile, the rail and the frame.

This invention is simple in structure. By combing the cheap FJL/LVL base with the relatively expensive veneer face, this invention has the following advantages: first, it reduces the cost of making wood shutters; secondly, it meets the customer's need for window shutters made of expensive wood species; thirdly, it helps solve the shortage of some rare wood species.

1. A wooden veneer-faced window shutter, comprising a variety of shutter components, wherein the components comprise a blade, a stile, a rail and a frame, wherein the blade, the stile, the rail and the frame comprise a poplar (or other inexpensive soft wood species) FJL/LVL base and a layer of wood veneer face. The said base and veneer face are glued together with E0 glue.

2. The wooden veneer-faced window shutter of claim 1 wherein said the wood veneer include red oak, white oak, white ash, black walnut, beech, maple and basswood.

3. The wooden veneer-faced window shutter of claim 1 wherein said the wood veneer shall be heated and pressed on the base at the temperature of 50° C.-55° C. with E0 glue. The said heating and pressing could be done either with machines or manually.

4. The wooden veneer-faced window shutter of claim 1 wherein said the wood veneer is rotary cut veneer of 0.1-1.0 mm in thickness.

5. The wooden veneer-faced window shutter of claim 1 wherein said the shape of the inner base is in conformity with the shape of the blade, the stile, the rail and the frame.
